(19) United States
(12) Patent Application Publication
(10) Pub. No.: US 2003/0140668 A1
(43) Pub. Date: Jul. 31, 2003

(54) Lock assembly with a piece moved by a magnetic member in a key

(76) Inventor: Shui Shan Chao, Pin-Tong Hsieh (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/058,800

(22) Filed: Jan. 30, 2002

(51) Int. Cl. E05B 27/04

(52) U.S. Cl. 70/359

(57) ABSTRACT

A lock assembly includes a core rotatably received in a casing and the core has first passages each having a first pin received therein. The casing has a protrusion in which second passages are defined and located in alignment with the first passages. Each second passage has a second pin received therein and biased by a spring so as to push a lower end of each first pin extended in the key way in the core. The second pins are located at a boundary surface between the core and the casing. A piece is received in the first passage and located at the boundary surface. A key with serration has a magnetic member which attracts the piece to move toward the key so that the piece is moved and the core is rotated relative to the casing.

### FIELD OF THE INVENTION

The present invention relates to a lock device having a piece which can only be moved toward the key by a magnetic member in the key.

### BACKGROUND OF THE INVENTION

A conventional lock device 40 is shown in FIG. 5 and generally includes a core 41 which is rotatably received in a casing 42. The core 41 has a key way 411 defined longitudinally therein so as to receive a key therein and a plurality of first passages 412 are defined radially through the core 41. Each first passage 412 has a first pin 43 movably received therein and a protrusion 421 connected to the core 41 and has a plurality of second passages 422 which are located in alignment with the first passages 412. Each second passage 422 has a second pin 44 received therein and the second pins 44 are urged by a spring 45 respectively. The first pins 43 extend into the key way 411 and the second pins 44 are located across the boundary surface between the core 41 and the protrusion 421 so that the core 41 cannot rotated relative to the fixed protrusion 421. A key having serrations can be inserted in the key way 411 in the core 41 and the first pins 43 are then lifted toward the protrusion 421 by the serrations. The second pins 44 are then moved by the movement of the first pins 43 to a position where the core 41 is able to be rotated relative to the protrusion 421. By the correct key, the core 41 is rotated and the lock is unlocked. However, the key can be copied easily by making the same serrations in a plate.

### SUMMARY OF THE INVENTION

In accordance with one aspect of the present invention, there is provided a lock assembly which comprises a lock device comprising a core rotatably received in a casing. The core has a key way and a plurality of first passages in which first pins are respectively received except one first passage in which a sleeve is received. A flange extends inward from a first open end of the sleeve and a spring is received in the sleeve and an end of the spring is rested on the flange. A piece is movably received in the sleeve and a head of the piece is engaged with the other end of the spring. The piece is located at a boundary surface between the core and the casing.

A protrusion extends radially from the casing and a plurality of second passages are defined through the protrusion. The second passages are located in alignment with and in communication with the first passages. Each second passage has a second pin received therein and a spring is biased between the second pin and a top plate sealing the second passages.

A key includes a blade and a plurality of recesses are defined in a surface of the key. A magnetic member is received in the key and attracts and moves the piece when the key is inserted in the key way.

The primary object of the present invention is to provide a lock device including a piece which is located at a boundary surface between the core and the casing, the piece can only moved by attracted by a magnetic member in the key.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a lock assembly of the present invention;

FIG. 2 is a cross sectional view to show the lock device when the key is not inserted in the key way;

FIG. 3 is a cross sectional view to show the pins and the piece are moved to allow the core to be rotatable relative to the casing when a correct key is inserted in the key way;

FIG. 4 is a cross sectional view to show the piece is not moved when a incorrect key is inserted in the key way; and

FIG. 5 is a cross sectional view to show a conventional lock device.

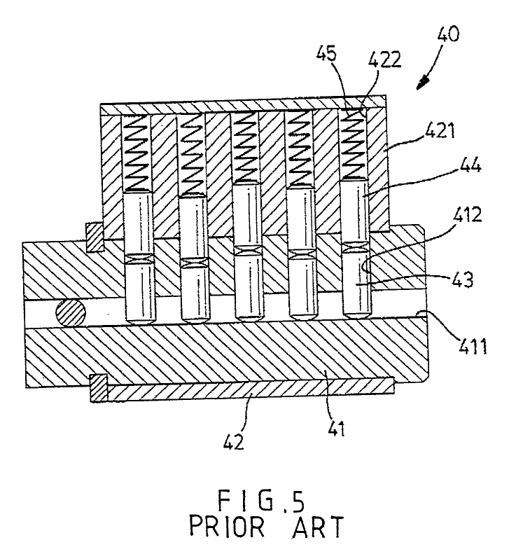

### DETAILED DESCRIPTION OF THE PREFERRED EMBODIMENT

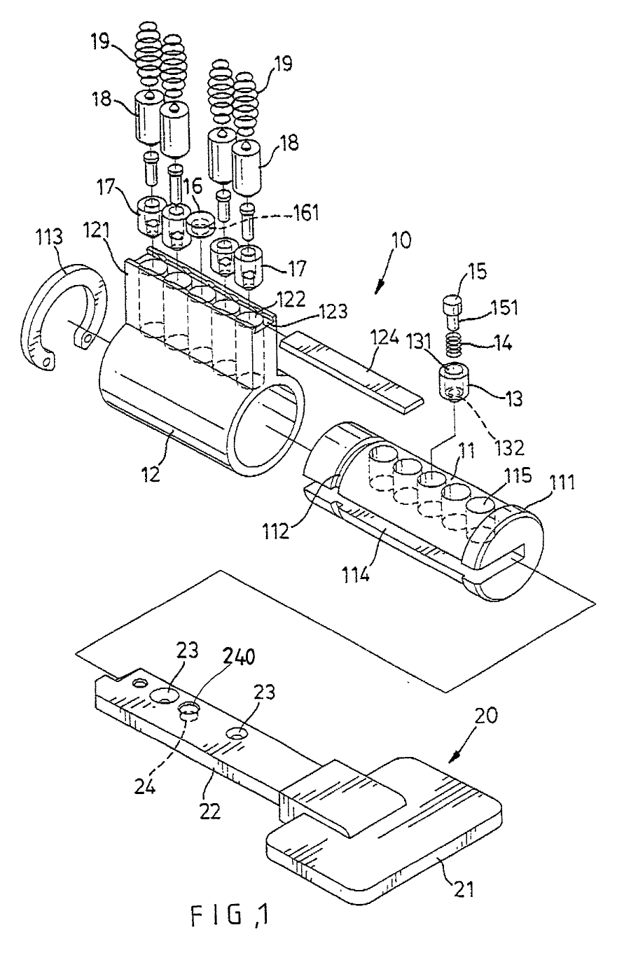

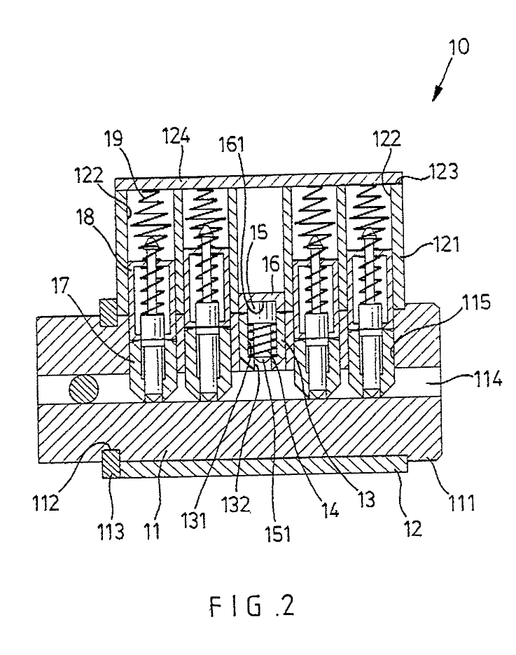

Referring to FIGS. 1 and 2, the lock assembly of the present invention comprises a lock device 10 comprising a core 11 which is rotatably received in a casing 12 by using a C-clamp 113 engaged with a groove 112 in an end of the core 11. The core 11 has a key way 114 defined longitudinally therein and a plurality of first passages 115 are defined radially in the core 11. A sleeve 13 is received in one of the first passages 115 and the rest of the first passages 115 each have a first pin 17 received therein. The lower ends of the first pins 17 extend in the key way 114.

A flange 132 extends inward from a first open end of the sleeve 13 and a spring 14 is received in the sleeve 13. An end of the spring 14 is rested on the flange 132. A piece 151 is movably inserted in the sleeve 13 from a second open end 131 of the sleeve 13. A head 15 of the piece 151 is engaged with the other end of the spring 14 and a cap 16 seals the second open end of the sleeve 13. The cap 16 has a recess 161 to receive the head 15 of the piece 151. The piece 151 is located at a boundary surface between the core 11 and the casing 12.

A protrusion 121 extends radially from the casing 12 and a plurality of second passages 122 are defined through the protrusion 121. The second passages 122 are located in alignment with and in communication with the first passages 115. A top plate 124 is slidably engaged with. Each second passage 122 has a second pin 18 received therein and a spring 19 is biased between the second pin 18 and the top plate 124 in each of the second passages 122. At least one of the first pins 17 and at least one of the second pins 18 are located at the boundary surface between the core 11 and the casing 12. Therefore, the core 11 cannot be rotated because the at least one of the first pins 17, the at least one of the second pins 18 and the piece 151 are located at the boundary surface between the core 11 and the casing 12.

A key 20 has a blade 22 and a bow 21. The blade 22 has a plurality of recesses 23 defined in a surface of the key 20 and a magnetic member 24 is received in the key 20. A dim 240 is defined in the surface of the key 22 and the magnetic member 24 is located beneath the dim 240 in the blade 22 of the key 20.

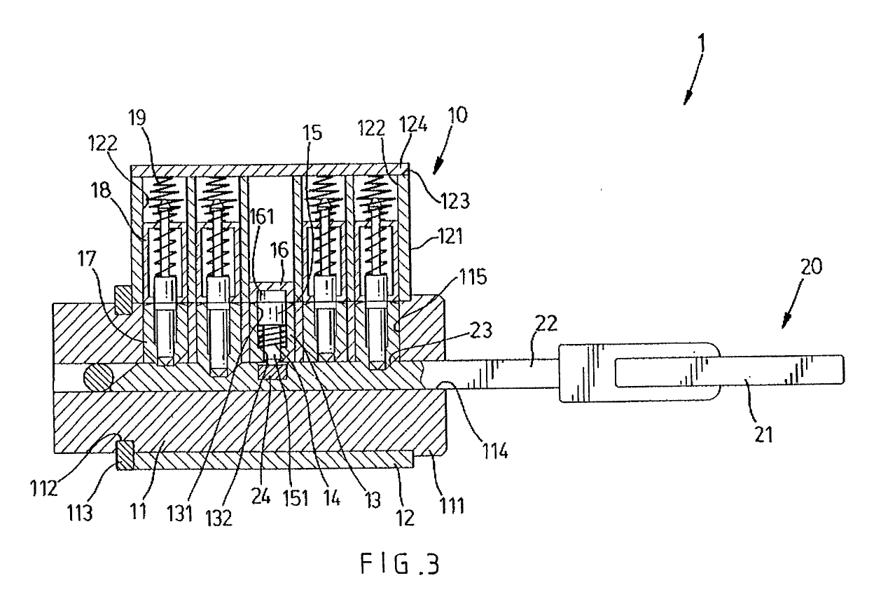

Referring to FIG. 3, when the key 20 is inserted in the key way 114, the first pins 17 are lifted by the recesses 23 so that the second pins 18 are moved to press the springs 19, and the contact surfaces of the first pins 17 and the second pins 18 are located at the boundary surface between the core 11 and the casing 12. In addition, the piece 151 is attracted by the magnetic member 24 and the spring 14 is pressed by the head 15 so that the lower end of the piece 151 extends through the hole enclosed by the flange 312 and engaged with the dim 240. The movement of the piece 151 shifts the piece 151 and is not located at the boundary surface between the core 11 and the casing 12. Therefore, the core 11 can be rotated relative to the casing 12. It is to be noted that the lower end of the piece 151 is not extended in the key way 114 and is not moved except for the magnetic member 24.

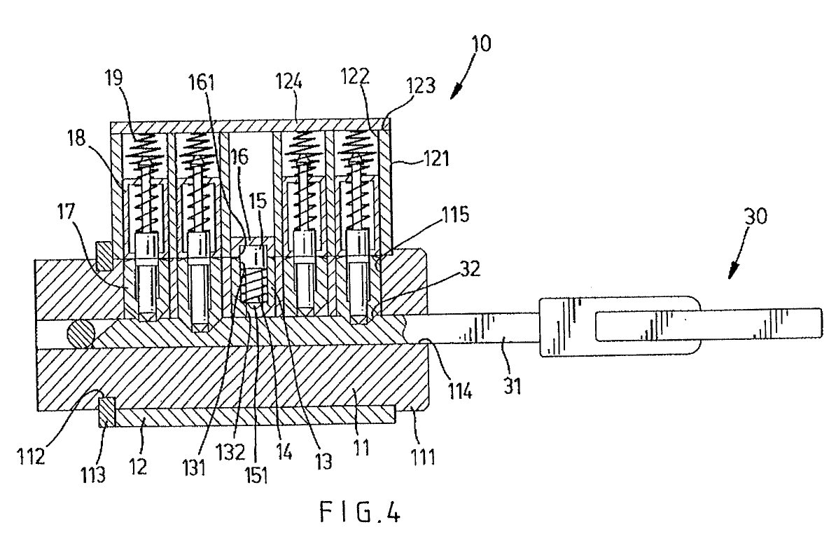

In other words, as shown in FIG. 4, if the key 20 is copied as a fake key 30, although the positions and depth of the recesses 32 in the blade 31 of the fake key 30 are copied exactly the same as the correct key 20 has, the piece 151 is still located at the boundary surface between the core 11 and the casing 12 so that the core 11 is not rotated.

While we have shown and described the embodiment in accordance with the present invention, it should be clear to those skilled in the art that further embodiments may be made without departing from the scope of the present invention.

What is claimed is:

1. A lock assembly comprising:
a lock device comprising a core which is rotatably received in a casing, said core having a key way defined longitudinally therein and a plurality of first passages are defined radially in said core, a sleeve received in one of said first passages and the rest of said first passages each having a first pin received therein, said first pins extended in said key way, a flange extending inward from a first open end of said sleeve, a spring received in said sleeve and an end of said spring rested on said flange, a piece movably received in said sleeve and a head of said piece engaged with the other end of said spring, said piece located at a boundary surface between said core and said casing;
a protrusion extending radially from said casing and a plurality of second passages defined through said protrusion, said second passages located in alignment with and in communication with said first passages, a top plate connected to said protrusion and sealing said second passages, each second passage having a second pin received therein and a spring biased between said second pin and said top plate in each of said second passages, and
a key having a blade and a plurality of recesses defined in a surface of said key, a magnetic member received in said key and attracting and moving said piece when said key is inserted in said key way.

2. The assembly as claimed in claim 1 further comprising a dim defined in said surface of said key and said magnetic member located beneath said dim in said blade of said key, said piece extending through a hole enclosed by said flange and engaged with said dim when said key inserted in said key way.

3. The assembly as claimed in claim 1 further comprising a groove defined in a top of the protrusion and a top cap engaged with said groove and seals said second passages.

4. The assembly as claimed in claim 1 wherein an end opposite to said head of said piece is not located in said key way.
